(19) United States
(12) Patent Application Publication
(10) Pub. No.: US 2025/0366520 A1
(43) Pub. Date: Dec. 4, 2025

(54) ATOMIZATION DEVICE

(71) Applicant: HG INNOVATION LIMITED, Hong Kong (CN)

(72) Inventors: Weiming ZHANG, Hong Kong (CN); Zhiliang ZHANG, Hong Kong (CN)

(73) Assignee: HG INNOVATION LIMITED, Hong Kong (CN)

(21) Appl. No.: 19/009,421

(22) Filed: Jan. 3, 2025

Related U.S. Application Data
(63) Continuation of application No. PCT/CN2024/140329, filed on Dec. 18, 2024.

(30) Foreign Application Priority Data
May 28, 2024 (CN) 202410674600.X

(51) Int. Cl. A24F 40/46; A24F 7/00; A24F 40/10; A24F 40/30; A24F 40/42; A24F 40/48; A24F 40/51; A24F 40/57; H05B 1/02; H05B 3/34

(52) U.S. Cl. CPC A24F 40/46; A24F 7/00; A24F 40/10; A24F 40/30; A24F 40/42; A24F 40/48; A24F 40/51; A24F 40/57; H05B 1/0252; H05B 3/34

(57) ABSTRACT

An atomization device is provided. The atomization device includes an outer housing, a first atomization mechanism and a second atomization mechanism. The first atomization mechanism and the second atomization mechanism are both disposed in the outer housing. The first atomization mechanism and the second atomization mechanism are configured to store and atomize an aerosol substrate. The volume of the first atomization mechanism is greater than the volume of the second atomization mechanism. The atomization device is configured to have at least two operating modes. In each of the at least two operating modes, the atomization power of the first atomization mechanism is greater than the atomization power of the second atomization mechanism.

### CROSS-REFERENCE TO RELATED APPLICATION(S)

This application is a continuation of International Application No. PCT/CN2024/140329 filed Dec. 18, 2024, which claims priority to Chinese Patent Application No. 202410674600.X filed May 28, 2024, the entire disclosures of each of which are incorporated herein by reference.

### TECHNICAL FIELD

This disclosure relates to the field of electronic atomization device technology, and in particular to an atomization device.

### BACKGROUND

Atomization devices can atomize aerosol substrates for use by users. With the popularity of the atomization device, the user has increasingly higher requirements for the atomization device. Existing atomization device generally only has one atomization mechanism with one structure, which has a single function and a limited atomization effect, and cannot meet the diversity requirements of the user for atomizing the aerosol substrate.

### SUMMARY

According to embodiments of the present disclosure, an atomization device is provided. The atomization device includes an outer housing, a first atomization mechanism, and a second atomization mechanism. The first atomization mechanism and the second atomization mechanism are both disposed in the outer housing. The first atomization mechanism and the second atomization mechanism are configured to store and atomize an aerosol substrate. A volume of the first atomization mechanism is greater than a volume of the second atomization mechanism. The atomization device is configured to have at least two operating modes. In each of the at least two operating modes, an atomization power of the first atomization mechanism is greater than an atomization power of the second atomization mechanism.

### BRIEF DESCRIPTION OF THE DRAWINGS

FIG. 1 is a schematic structural view of an atomization device in an embodiment.

FIG. 2 is a cross-sectional view of an atomization device in an embodiment.

FIG. 3 is an exploded structural view of an atomization device in an embodiment.

### DETAILED DESCRIPTION

In order to clear purposes, technical solutions, and advantages of embodiments of the present disclosure, the following will clearly and completely describe the technical solutions of embodiments of the present disclosure with reference to the accompanying drawings of the embodiments of the present disclosure. Apparently, the embodiments described herein are merely some embodiments, rather than all embodiments of the present disclosure. Based on the embodiments of the present disclosure, all other embodiments obtained by those of ordinary skill in the art without creative effort shall fall within the protection scope of the present disclosure.

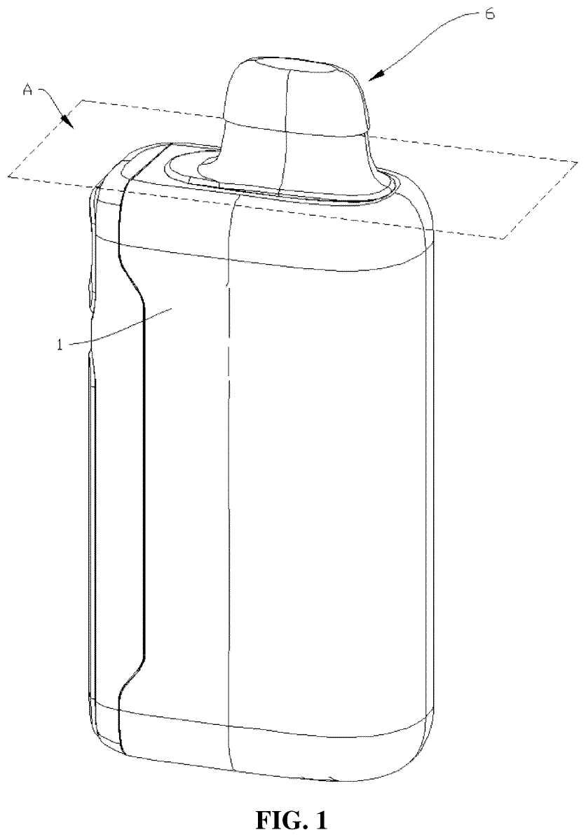

Embodiments about an atomization device in the present disclosure will be described below with reference to FIG. 1 to FIG. 3.

According to an embodiment of the present disclosure, an atomization device is provided. The atomization device including an outer housing 1, a first atomization mechanism 21, a second atomization mechanism 22, and a power supply assembly 3. The first atomization mechanism 21 and the second atomization mechanism 22 are both disposed in the outer housing 1. The first atomization mechanism 21 and the second atomization mechanism 22 are configured to store and atomize an aerosol substrate. The volume of the first atomization mechanism 21 is greater than the volume of the second atomization mechanism 22. The atomization device is configured to have at least two operating modes. In each of the at least two operating modes, the atomization power of the first atomization mechanism 21 is greater than the atomization power of the second atomization mechanism 22 to form different atomization effect. The power supply assembly 3 is disposed in the outer housing 1. The power supply assembly 3 is electrically connected to the first atomization mechanism 21 and the second atomization mechanism 22. The outer housing 1 includes a first housing 11 and a second housing 12.

The atomization device provided in this embodiment is provided with the first atomization mechanism 21 and the second atomization mechanism 22, the volume of the first atomization mechanism 21 is greater than the volume of the second atomization mechanism 22, and the atomization power of the first atomization mechanism 21 is greater than the atomization power of the second atomization mechanism 22. Therefore, different atomization effects can be formed with the aid of the first atomization mechanism 21 and the second atomization mechanism 22, and thus the diversity requirements of the user for the aerosol substrate atomization are met.

The volume of the first atomization mechanism 21 is greater than the volume of the second atomization mechanism 22, where the volume herein refers to the volume capable of accommodating the aerosol substrate. In some embodiments, the volume of the aerosol substrate in the first atomization mechanism 21 is greater than the volume of the aerosol substrate in the second atomization mechanism 22. The atomization power of the first atomization mechanism 21 is greater than the atomization power of the second atomization mechanism 22. Therefore, the concentration of the vapor atomized by the first atomization mechanism 21 is greater than the concentration of the vapor atomized by the second atomization mechanism 22.

In some embodiments, the atomization device has a first operating state and a second operating state. In the first operating state, only the first atomization mechanism 21 is in operation. In the second operating state, both the first atomization mechanism 21 and the second atomization mechanism 22 are in operation. Even when the first atomization mechanism 21 is used alone, a good taste can also be provided. On the basis of the operation of the first atomization mechanism 21, the simultaneous operation of the second atomization mechanism 22 can increase the total atomization power of the atomization device, thereby changing the total concentration of the vapor and adjusting the suction taste of the atomization device. In addition, since the power of the second atomization mechanism 22 is less than the power of the first atomization mechanism 21, the degree of taste change is within an appropriate range, and excessive difference in taste is not generated, so that discomfort is reduced, and the taste change is softer and more acceptable. Meanwhile, the volume of the first atomization mechanism 21 is greater than the volume of the second atomization mechanism 22, and the atomization power of the first atomization mechanism 21 is also greater than the atomization power of the second atomization mechanism 22, so that the speed difference of the first atomization mechanism 21 and the second atomization mechanism 22 consuming the aerosol substrate can be reduced, and the waste of the aerosol substrate in the first atomization mechanism 21 or the second atomization mechanism 22 can be reduced, thereby improving the use experience of the user.

In the first operating state, only the first atomization mechanism 21 is in operation, and the first atomization mechanism 21 may have one or more operating modes. In the second operating state, both the first atomization mechanism 21 and the second atomization mechanism 22 are in operation, the first atomization mechanism 21 may have one or more operating modes, and the second atomization mechanism 22 may have one or more operating modes, so that the concentration of the vapor at each puff of the user is changed compared with that in the first operating state. Accordingly, the taste also changes, and the user can switch the operating states of the atomization device according to his/her own requirements for the taste.

In some embodiments, the atomization device may additionally have other operating states. For example, in a third operating state, only the second atomization mechanism 22 is in operation, so as to meet the use requirements of the taste with lower vapor concentration. A fourth operating state may also be provided. In the fourth operating state, the first atomization mechanism 21 is in continuous operation, and the second atomization mechanism 22 is in intermittent operation, so that the vapor concentration changes intermittently, resulting in intermittent and jump-like change in the taste, and improving the use experience.

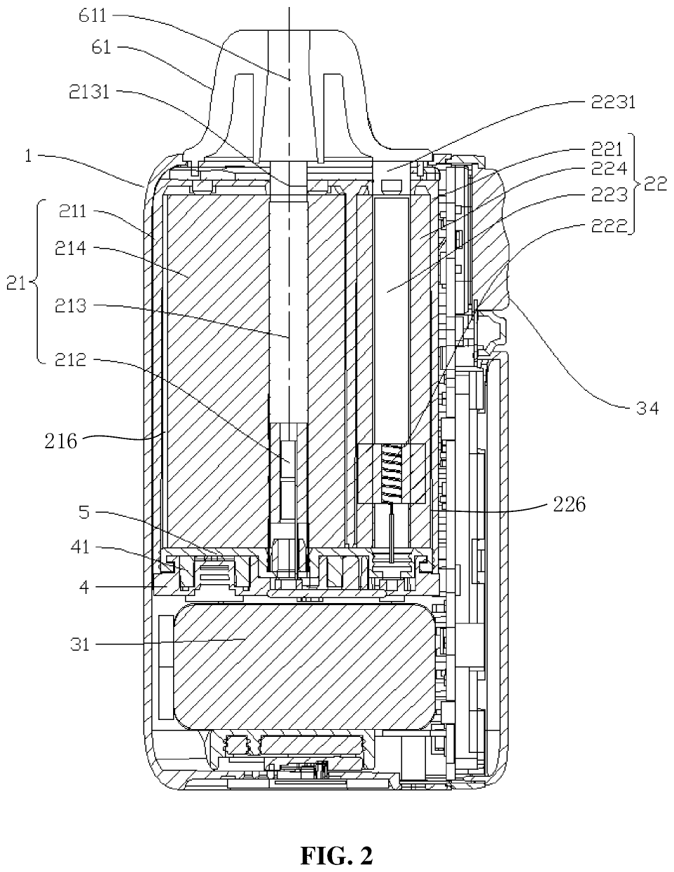

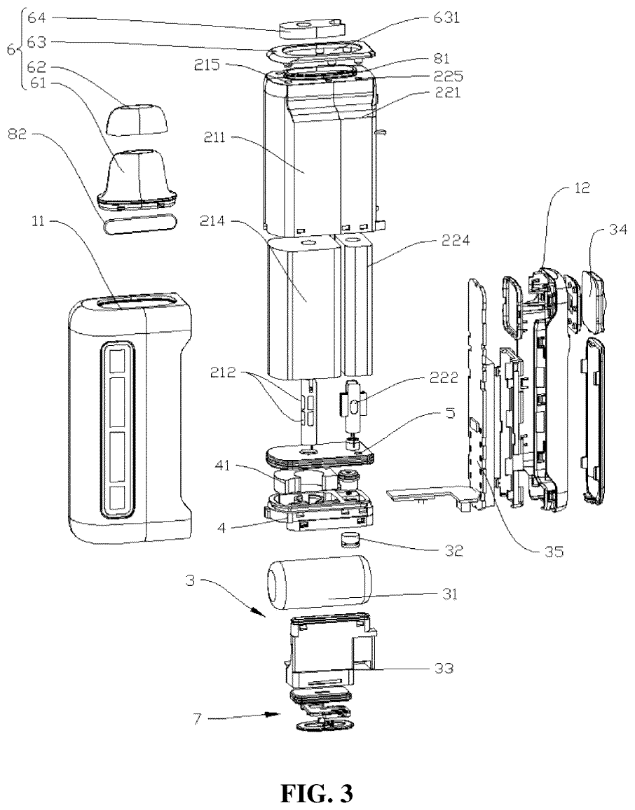

As illustrated in FIG. 2 and FIG. 3, in one or more embodiments, the first atomization mechanism 21 includes multiple first atomization elements 212, and the second atomization mechanism 22 includes one second atomization element 222. The multiple first atomization elements 212 enable the atomization power of the first atomization mechanism 21 to be greater than the atomization power of the second atomization mechanism 22 provided with only one second atomization element 222, resulting in the taste difference between the first atomization mechanism 21 and the second atomization mechanism 22.

In this embodiment, the first atomization mechanism 21 includes multiple first atomization units 212, and the second atomization mechanism 22 includes one second atomization unit 222. Therefore, the atomization power of the first atomization mechanism 21 may be twice the atomization power of the second atomization mechanism 22. Due to this setting, the atomization device can have relatively obvious taste change during operation, and the degree of taste change is not too large, so that the discomfort is reduced, the taste change is softer and more acceptable, thereby improving the use experience of the user. In other embodiments, the proportional relationship between the atomization power of the first atomization mechanism 21 and the atomization power of the second atomization mechanism 22 can be set according to actual needs of the user, and can be adjusted by adjusting the number of the first atomization elements 212 and the number of the second atomization elements 222. For example, the atomization power of the first atomization mechanism 21 may be 1.5 times, 2.5 times, 3 times, 4 times, 5 times, etc., the atomization power of the second atomization mechanism 22.

In this embodiment, the first atomization element 212 is a heating net, and the second atomization element 222 is a heating wire. In some embodiments, the first atomization element 212 may be a heating sheet or a heating wire, and the second atomization element 222 may be a heating sheet or a heating wire.

In one or more embodiments, the first atomization mechanism 21 includes a first inner housing 211. The second atomization mechanism 22 includes a second inner housing 221. The first inner housing 211 and the second inner housing 221 share one side wall. When the first inner housing 211 and the second inner housing 221 share one side wall, the volume occupied by the first inner housing 211 and the second inner housing 221 can be reduced, the manufacturing cost can be reduced, and the first inner housing 211 and the second inner housing 221 can be tightly connected to each other.

The atomization device further includes an inner housing base 4. The inner housing base 4 is disposed in the outer housing 1. The first inner housing 211 and the second inner housing 221 are both connected to the inner housing base 4. A mounting first cavity 216 is defined by the first inner housing 211 and the inner housing base 4. A second mounting cavity 226 is defined by the second inner housing 221 and the inner housing base 4. The first mounting cavity 216 and the second mounting cavity 226 are independent from each other. The aerosol substrate in the first mounting cavity 216 and the aerosol substrate in the second mounting cavity 226 do not penetrate each other. The first atomization element 212 is disposed in the first mounting cavity 216 defined between the first inner housing 211 and the inner housing base 4. The second atomization element 222 is disposed in the second mounting cavity 226 defined between the second inner housing 221 and the inner housing base 4. Therefore, the first atomization mechanism 21 and the second atomization mechanism 22 each can atomize and store the atomization substrate independently, so that the atomization substrate in the first atomization mechanism 21 and the atomization substrate in the second atomization mechanism 22 are prevented from penetrating each other, thereby preventing affecting the taste of the atomization gas.

In some embodiments, the first inner housing 211 is integrated with the second inner housing 221, so that the manufacturing difficulty is low, the manufacturing cost is low, and the strength of the connection between the first inner housing 211 and the second inner housing 221 is further improved.

In some embodiments, the first inner housing 211 defines first injection holes 215. The second inner housing 221 defines at least one second injection hole 225. The number of (that is, quantity of) the first injection holes 215 is greater than the number of the at least one second injection hole 225. The aerosol substrate can be added into the first mounting cavity 216 defined by the first inner housing 211 and the inner housing base 4 through the first injection holes 215. The aerosol substrate can be added into the second mounting cavity 226 defined by the second inner housing 221 and the inner housing base 4 through the at least one second injection hole 225. Therefore, the times of replacing the atomization device by the user can be reduced, thereby facilitating the user to switch between different tastes of the aerosol substrates.

In this embodiment, there are four first injection holes 215 and two second injection holes 225. In other embodiments, the number of the first injection holes 215 and the number of the at least one second injection hole 225 may be set according to the volume of the first inner housing 211 and the volume of the second inner housing 221.

In some embodiments, the first inner housing 211 defines a first air outlet 2131. The second inner housing 221 defines a second air outlet 2231. The atomization device further includes an annular sealing boss 81 and a nozzle assembly 6. The nozzle assembly 6 includes a nozzle body 61 and a second sealing member 63. The first air outlet 2131 and the second air outlet 2231 defined at the inner side of the annular sealing boss 81. The second sealing member 63 is configured to seal the first injection holes 215 and the at least one second injection hole 225. The second sealing member 63 defines a mounting hole 631. The nozzle assembly 6 is in sealing connection to the annular sealing boss 81, and the annular sealing boss 81 and a part of the nozzle assembly 6 are disposed in the mounting hole 631.

The nozzle body 61 is in sealing connection to the annular sealing boss 81, so that the first air outlet 2131 and the second air outlet 2231 can be sealed, thereby preventing the aerosol substrate from flowing into the outer housing 1 through the first air outlet 2131 or the second air outlet 2231. The second sealing member 63 can seal the first injection holes 215 and the at least one second injection hole 225 to prevent the aerosol substrate from leaking. The nozzle body 61 is in sealing connection to the annular sealing boss 81, and the annular sealing boss 81 and a part of the nozzle body 61 are disposed in the mounting hole 631, so that the nozzle body 61 is stably mounted, and the nozzle body 61 is prevented from falling off.

In some embodiments, the nozzle body 61 is in an interference connection with the mounting hole 631, and the annular sealing boss 81 is connected to the nozzle body 61 via a sealing ring 82, so that the sealing effect at the nozzle is improved to avoid the leakage of the aerosol substrate, and the connection strength at the nozzle assembly 6 is improved to avoid the nozzle assembly 6 from falling off.

In this embodiment, the sealing ring 82 is a rubber sealing ring 82. In other embodiments, the sealing ring 82 may be a silica gel sealing ring 82.

In some embodiments, the nozzle assembly 6 defines an air outlet channel 611. The first atomization mechanism 21 defines a first channel 213. An orthographic projection of the first channel 213 on a plane A at least partially overlaps an orthographic projection of the air outlet channel 611 on the plane A. The vapor atomized by the first atomization mechanism 21 through the first atomization element 212 is discharged from the first inner housing 211 through the first channel 213. Since the first atomization mechanism 21 operates in both the first operating state and the second operating state, the above arrangement enables the vapor produced by the first atomization mechanism 21 to enter the air outlet channel 611 more smoothly through the first channel 213, thereby ensuring the use experience in the first operating state and the second operating state for the user.

It may be noted that, as illustrated in FIG. 1, the plane A is a plane perpendicular to an axis of the first channel 213.

In this embodiment, the first channel 213 is coaxial with the outlet channel 611. In other embodiments, the first channel 213 may be not coaxial with the outlet channel 611.

In some embodiments, the second atomization mechanism 22 defines a second channel 223. The vapor atomized by the second atomization element 222 in the second atomization mechanism 22 is discharged from the second inner housing 221 through the second channel 223 and then enters the nozzle assembly 6. The vapor from the first atomization mechanism 21 and the vapor from the second atomization mechanism 22 are fully mixed in the nozzle assembly 6, thereby improving the mouthfeel.

The first channel 212 extends through the top wall of the first inner housing 211 close to the nozzle assembly 6 to define the first air outlet 2131. The second channel 223 extends through the top wall of the second inner housing 221 close to the nozzle assembly 6 to define the second air outlet 2231.

In some embodiments, as illustrated in FIG. 2 and FIG. 3, the outer housing 1 further defines an air inlet and a suction port. The nozzle assembly 6 is disposed at the suction port, to facilitate the user for suction. Meanwhile, the vapor from the first atomization mechanism 21 and the vapor from the second atomization mechanism 22 can be fully mixed in the nozzle assembly 6, so as to provide a better taste and mouthfeel.

The nozzle assembly 6 further includes a blocking member 62. The nozzle body 61 is disposed at the suction port. The user can conveniently perform suction by means of the nozzle. When the atomization device does not need to be used, the nozzle body 61 can be blocked by the blocking member 62, thereby preventing the aerosol substrate from leaking or prevent dust and debris from entering the nozzle body 61. The blocking member 62 may be a rubber plug, a rubber cap, a plastic plug, a plastic cap, or the like.

In some embodiments, the nozzle assembly 6 further includes a first liquid-storage portion 64. The first liquid-storage portion 64 is disposed at the suction port and can absorb and store the aerosol substrate, so that the flow of the aerosol substrate into the nozzle body 61 through the first channel 213 and/or the second channel 223 is reduced, and the suction experience of the user is improved.

In some embodiments, the first atomization mechanism 21 is configured to be detachably coupled to the second atomization mechanism 22, so that the user can replace the first atomization mechanism 21 and/or the second atomization mechanism 22, thereby meeting different use requirements.

The atomization device further includes a power supply assembly 3. When the power supply assembly 3 supplies power to the first atomization mechanism 21, the first atomization mechanism 21 can atomize the aerosol substrate stored in the first atomization mechanism 21. When the power supply assembly 3 supplies power to the second atomization mechanism 22, the second atomization mechanism 22 can atomize the aerosol substrate stored in the second atomization mechanism 22. By means of different atomization powers of the first atomization mechanism 21 and the second atomization mechanism 22, a gentle change in the suction mouthfeel can be achieved. Meanwhile, different types of aerosol substates may also be stored in the first atomization mechanism 21 and the second atomization mechanism 22, so that more suction taste can be obtained, and the user experience can be improved.

In some embodiments, the volume of the first atomization mechanism 21 is at least twice the volume of the second atomization mechanism 22, which can be matched with the atomization power of the first atomization mechanism 21 and the atomization power of the second atomization mechanism 22. In this way, the speed difference of the first atomization mechanism 21 and the second atomization mechanism 22 consuming the aerosol substrate can be reduced, so that the aerosol substrate can be exhausted as much as possible, thereby further reducing the waste of the aerosol substrate in the first atomization mechanism 21 or the second atomization mechanism 22.

In some embodiments, the power supply assembly 3 includes a power source 31, an airflow sensing element 32, and a control member 35. Both the first atomization mechanism 21 and the second atomization mechanism 22 are electrically connected to the power source 31. The airflow sensing element 32 and the power source 31 are electrically connected to the control member 35. The control member 35 controls the power source 31 to supply power to the first atomization mechanism 21, or to supply power to both the first atomization mechanism 21 and the second atomization mechanism 22, in response to the airflow sensing element 32 being activated.

When the user uses the atomization device, the user sucks the atomization device, the airflow sensing element 32 is configured to detect an airflow signal and convert the airflow signal into an electrical signal, and then transmit the electrical signal to the control member 35. The control member 35 is configured to control the power source 31 to supply power to the first atomization mechanism 21 and/or the second atomization mechanism 22 according to the electrical signal, so that the first atomization element 212 performs atomization operation, or the first atomization element 212 and the second atomization element 222 perform atomization operation.

In this embodiment, the airflow sensing element 32 is a microphone sensor. The control member 35 is a printed circuit board (PCB).

In other embodiments, the airflow sensing element 32 may also be a semiconductor air sensor, an infrared air sensor, etc.

In some embodiments, the first inner housing 211 is mainly configured to store a base aerosol substrate. The volume of the first inner housing 211 determines the amount of the base aerosol substrate that can be stored in the first atomization mechanism 21. The first atomization element 212 is configured to atomize the base aerosol substrate in the first inner housing 211, and the vapor formed by atomizing the base aerosol substrate is discharged from the first inner housing 211 through the first channel 213.

In some embodiments, the second inner housing 221 is mainly configured to store a flavor aerosol substrate. The volume of the second inner housing 221 determines the amount of the flavor aerosol substrate that can be stored in the second atomization mechanism 22, the second atomization element 222 is configured to atomize the flavor aerosol substrate in the second inner housing 221, and the vapor formed by atomizing the flavor aerosol substrate is discharged from the second inner housing 221 through the second channel 223.

The aerosol substrate stored in the first atomization mechanism 21 is the base aerosol substrate. The base aerosol substrate refers to a regular taste in this embodiment. The flavor aerosol substrate refers to a flavor taste different from the regular taste. Therefore, the regular taste can be mixed with the flavor taste to obtain a better taste and mouthfeel.

The present disclosure does not limit the specific type of the flavor aerosol substrate. In this embodiment, the flavor aerosol substrate includes one or more kinds of aerosol substrate accompanied with a cool taste, aerosol substrate accompanied with a sweet taste, and aerosol substrate accompanied with a sour taste. By combining the base aerosol substrate and the flavor aerosol substrate, different tastes can be obtained, the number of suction tastes is increased, the requirements of the user are better met, and the use experience is improved.

In some embodiments, the first atomization mechanism 21 further includes a first liquid-storage element 214. The first liquid-storage element 214 is disposed in the first inner housing 211. The first channel 213 extends through the first liquid-storage element 214. The first liquid-storage element 214 can absorb and store the base aerosol substrate, effectively fix the base aerosol substrate, and reduce leakage of the base aerosol substrate, thereby avoiding waste or influence on the suction mouthfeel.

Accordingly, the second atomization mechanism 22 further includes a second liquid-storage element 224. The second liquid-storage element 224 is disposed in the second inner housing 221. The second channel 223 extends through the second liquid-storage element 224. The second liquid-storage element 224 can absorb and store the flavor aerosol substrate. The second liquid-storage element 224 can effectively fix the flavor aerosol substrate, and reduce leakage of the flavor aerosol substrate, thereby avoiding waste or influence on the suction mouthfeel.

The present disclosure does not limit the specific types of the first liquid-storage element 214 and the second liquid-storage element 224. In this embodiment, both the first liquid-storage element 214 and the second liquid-storage element 224 employ oil storage cotton. The oil storage cotton has a large oil storage capacity, a good fixing effect, a light weight, and a low cost.

In other embodiments, the first fluid-storage element 214 and the second fluid-storage element 224 may also employ an oil storage block, oil storage fibers, or the like.

In some embodiments, the atomization device further includes a first sealing member 5. The first sealing member 5 is disposed between the inner housing base 4 and the first inner housing 211, and between the inner housing base 4 and the second inner housing 221, and can further seal the first inner housing 211 and the second inner housing 221, thereby reducing the possibility of the aerosol substrate leakage.

In this embodiment, the first sealing member 5 is a silica gel sealing member, which has a good sealing effect and a long service life. In other embodiments, the first sealing member 5 may also be a rubber sealing member.

In some embodiments, a second liquid-storage portion 41 is further disposed in the inner housing base 4. The second liquid-storage portion 41 can absorb and store the aerosol substrate. When the aerosol substrate leaks from the first inner housing 211 and/or the second inner housing 221, the second liquid-storage portion 41 can absorb the leaking aerosol substrate, thereby reducing the possibility of the aerosol substrate leaking out of the atomization device.

In this embodiment, the second liquid-storage portion 41 employs oil storage cotton, which has a good absorption effect and a light weight. In other embodiments, the second liquid-storage portion 41 may employ oil storage fibers.

In some embodiments, the power supply assembly 3 further includes a bracket 33. The bracket 33 is connected to the outer housing 1. The power source 31 is disposed on the bracket 33. Therefore, the power source 31 can be firmly provided, and the possibility of looseness of the power source 31 is reduced, so that the power source 31 can stably supply power to the first atomization mechanism 21 and the second atomization mechanism 22.

In some embodiments, the power supply assembly 3 further includes an operating member 34. The operating member 34 is disposed on an outer wall of the outer housing 1 and is electrically connected to the control member 35. The user can control the control member 35 to switch between the first operating state and the second operating state by operating the operating member 34. The operating member 34 facilitates the user to quickly switch and adjust the operating state of the atomization device. In this embodiment, the operating member 34 is a plastic button. In other embodiments, the operating member 34 may be a silica gel button.

In some embodiments, the atomization device further includes an air adjusting mechanism 7. The air adjusting mechanism 7 is disposed at the air inlet. The air adjusting mechanism 7 is configured to adjust a flow area of the air inlet. By adjusting the air intake volume, an atomization process of a first atomization chamber and a second atomization chamber can be matched, thereby further improving the suction mouthfeel. For example, in the second operating state, the air intake volume can be increased so that the atomized vapor can be quickly sucked out of the nozzle assembly 6, thereby improving a mouthfeel effect.

In this embodiment, the air adjusting mechanism 7 is a common air adjusting mechanism 7 in the art, and the specific structure of the air adjusting mechanism 7 is not described herein.

The basic operating process of the atomization device provided in an embodiment is as follows.

During use, the user first pulls out the blocking member 62 to suck through the nozzle body 61. The airflow enters the outer housing 1 through the air inlet. The airflow sensing element 32 detects an airflow signal, converts the airflow signal into an electrical signal, and sends the electrical signal to the control board. The control panel controls the power source 31 to supply power to the first atomization element 212 according to the electrical signal, or supplies power to both the first atomization element 212 and the second atomization element 222. Accordingly, the first atomization element 212 atomizes the aerosol substrate in the first inner housing 211; or the first atomization element 212 atomizes the aerosol substrate in the first inner housing 211, and the second atomization element 222 atomizes the aerosol substrate in the second inner housing 221.

In detail, the user can select the operating state of the atomization device through the operating member 34. When the atomization device is in the first operating state, the power source 31 only supplies power to the first atomization mechanism 21. In this case, the first atomization element 212 atomizes the base aerosol substrate in the first inner housing 211. The basic vapor formed by atomizing the base aerosol substrate is discharged from the first inner housing 211 through the first channel 213, and then passes through the nozzle body 61 for suction by the user.

When the atomization device is in the second operating state, the power source 31 supplies power to both the first atomization mechanism 21 and the second atomization mechanism 22. The first atomization element 212 atomizes the base aerosol in the first inner housing 211, and the basic vapor formed by atomizing the base aerosol substrate is discharged from the first inner housing 211 through the first channel 213. The second atomization element 222 in the second atomization mechanism atomizes the flavor aerosol substrate in the second inner housing 221. The flavor vapor formed by atomizing the flavor aerosol substrate is discharged from the second inner housing 221 through the second channel 223. Then, the basic vapor and the flavor vapor are fully mixed in the nozzle body 61 for suction by the user, thereby improving the mouthfeel.

After use, the user can plug the nozzle body 61 with the blocking member 62 to reduce leakage of the aerosol substrate or entry of debris and dust.

In other embodiments, according to different use requirements, the aerosol substrate with the same taste may also be stored in the first atomization mechanism 21 and the second atomization mechanism 22.

Although embodiments of the present disclosure have been described with reference to the accompanying drawings, those skilled in the art may make various modifications and variations without departing from the spirit and scope of the present disclosure, and all such modifications and variations fall within the scope defined by the appended claims.

What is claimed is:

1. An atomization device comprising:
an outer housing; and
a first atomization mechanism and a second atomization mechanism both disposed in the outer housing, wherein the first atomization mechanism and the second atomization mechanism are configured to store and atomize an aerosol substrate, wherein a volume of the first atomization mechanism is greater than a volume of the second atomization mechanism, the atomization device is configured to have at least two operating modes, and in each of the at least two operating modes, an atomization power of the first atomization mechanism is greater than an atomization power of the second atomization mechanism.

2. The atomization device of claim 1, wherein the first atomization mechanism comprises a plurality of first atomization elements, and the second atomization mechanism comprises one second atomization element.

3. The atomization device of claim 1, wherein the first atomization mechanism comprises a first inner housing, the second atomization mechanism comprises a second inner housing, and the first inner housing and the second inner housing share one side wall.

4. The atomization device of claim 3, wherein the first inner housing is configured to store a base aerosol substrate, and the second inner housing is configured to store a flavor aerosol substrate.

5. The atomization device of claim 3, further comprising an inner housing base, wherein the inner housing base is disposed in the outer housing, the first inner housing and the second inner housing are both connected to the inner housing base, a first mounting cavity is defined by the first inner housing and the inner housing base, a second mounting cavity is defined by the second inner housing and the inner housing base, the first mounting cavity and the second mounting cavity are independent from each other, and the aerosol substrate in the first mounting cavity and the aerosol substrate in the second mounting cavity do not penetrate each other.

6. The atomization device of claim 3, wherein the first inner housing is integrated with the second inner housing.

7. The atomization device of claim 3, wherein the first inner housing defines first injection holes, the second inner housing defines at least one second injection hole, and a number of the first injection holes is greater than a number of the at least one second injection hole.

8. The atomization device of claim 7, wherein the first inner housing defines a first air outlet, the second inner housing defines a second air outlet; and the atomization device further comprises a nozzle assembly and an annular sealing boss, the nozzle assembly comprises a nozzle body and a second sealing member, the first air outlet and the second air outlet are defined at an inner side of the annular sealing boss, the second sealing member is configured to seal the first injection holes and the at least one second injection hole, the second sealing member defines a mounting hole, the nozzle body is in sealing connection to the annular sealing boss, and the annular sealing boss and a part of the nozzle body are disposed in the mounting hole.

9. The atomization device of claim 8, wherein the nozzle body defines an air outlet channel, the first atomization mechanism defines a first channel, and an orthographic projection of the first channel on a plane perpendicular to an axis of the first channel at least partially overlaps an orthographic projection of the air outlet channel on the plane perpendicular to the axis of the first channel.

10. The atomization device of claim 9, wherein the first channel is coaxial with the air outlet channel.

11. The atomization device of claim 1, wherein the first atomization mechanism is configured to be detachably coupled to the second atomization mechanism.

12. The atomization device of claim 1, having a first operating state and a second operating state, wherein in the first operating state, only the first atomization mechanism is in operation, and in the second operating state, both the first atomization mechanism and the second atomization mechanism are in operation simultaneously.

13. The atomization device of claim 12, wherein in the first operating state, the first atomization mechanism has a plurality of operating modes.

14. The atomization device of claim 12, wherein in the second operating state, the first atomization mechanism and the second atomization mechanism each have a plurality of operating modes.

15. The atomization device of claim 12, having a third operating state, wherein in the third operating state, only the second atomization mechanism is in operation.

16. The atomization device of claim 1, having a fourth operating state, wherein in the fourth operating state, the first atomization mechanism is in continuous operation, while the second atomization mechanism is in intermittent operation.

17. The atomization device of claim 1, wherein the volume of the first atomization mechanism is at least twice the volume of the second atomization mechanism.

18. The atomization device of claim 1, further comprising a power supply assembly, wherein the power supply assembly comprises a power source, an airflow sensing element, and a control member, the first atomization mechanism and the second atomization mechanism are electrically connected to the power source, and the airflow sensing element and the power source are electrically connected to the control member; and
the control member is configured to control the power source to supply power to the first atomization mechanism, or to supply power to both the first atomization mechanism and the second atomization mechanism, in response to the airflow sensing element being activated.

19. The atomization device of claim 8, further comprising a sealing ring, wherein the nozzle body is in an interference connection with the mounting hole, and the annular sealing boss is connected to the nozzle body via the sealing ring.

20. The atomization device of claim 5, further comprising a first sealing member, wherein the first sealing member is disposed between the inner housing base and the first inner housing, and between the inner housing base and the second inner housing, and the first sealing member is configured to seal the first inner housing and the second inner housing.
